(19) United States
(12) Patent Application Publication
(10) Pub. No.: US 2005/0039196 A1
(43) Pub. Date: Feb. 17, 2005

(54) Method and system for using a library

(76) Inventor: Prasanth Nalini Sasidharan, Kovalam Thirvanathapuram (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/639,676

(22) Filed: Aug. 13, 2003

(51) Int. Cl. G06F 3/00

(52) U.S. Cl. 719/331

(57) ABSTRACT

A method for using a library. More particularly, a method for an application to use a function in a library. An application 1 compares the version 2 of a function 4 in a static form of the library with the version 3 of the function 5 in a dynamic form of the library. The application will use the dynamic function if the comparison indicates that it is more recent than the static function. The method may also be used for data exported from a library. The method may be used to repair defects in a library or to update the library by only making changes to a dynamic form of the library. A system and software for implementing the method are also disclosed.

### FIELD OF INVENTION

The present invention relates to a method and system for using a library. Particularly, but not exclusively, the present invention relates to a method and system for using the most recently updated function from either a static or dynamic form of a library.

### BACKGROUND

As static (archive) libraries provide performance advantages over dynamic link (shared) libraries, many performance critical applications would prefer static libraries. However software vendors shipping application binaries linked with static libraries would need to rebuild and re-ship their binaries if a defect is identified in a linked-in static library. This is because when an application is built with a static library it gets archived into the application binary itself. This is one of the reasons that static libraries are not preferred even though they provide considerable performance improvement.

Further disadvantages of existing methods to update libraries are outlined below:
If the library is a system library like libcres.a, which is linked into all applications, all the user space applications including compiler, linker and loader will have to be rebuilt if a defect is identified in a linked-in static library.
All software vendors shipping application binaries linked with static libraries will need to rebuild and re-ship their binaries if a defect is identified in a linked-in static library.
The cost of resolving a defect in an archive library is very high for both software developers/vendors and customers.
If the applications binaries are rebuilt, all tests need to be carried out again to ensure quality. This causes delays in defect fix delivery and increases cost.
Rebuilding the application binary increases product maintenance cost for the customer.

It is object of the present invention to provide a method which attempts to overcome the above disadvantages by providing a fail over mode for delivering fixes for defects in static libraries without requiring the application to be rebuilt.

### SUMMARY OF THE INVENTION

According to a first aspect of the invention there is provided a method for using a function from a library including the steps of:
i) comparing a version of the function in a static form of the library with a version of the function in a dynamic form of the library;
ii) using the function from the dynamic form of the library when the comparison indicates that the dynamic version is more recent than the static version; and
iii) using the function from the static form of the library when the comparison indicates that the dynamic version not being more recent than the static version.

Preferably each version of the function is recorded as a version code. The version code may be a numerical code which increases in value to indicate the oldest version to the most recent version. It is preferred that the version code of the function in the static form of the library is recorded within the static form of the library and the version code of the function in the dynamic form of the library is recorded within the dynamic form of the library.

Preferably the function in the static form of the library is identified by a symbol which is used by the application to call the function. The function in the static form of the library may include the comparison in step (i). It is preferred that when the application calls the function, the static function executes and performs the comparison in step (i) shortly after beginning execution.

The static form of the library may be archived within the application when the application is compiled.

The function may be an Application Programming Interface (API) or part of an API. The dynamic form of the library may be a Dynamic Linked Library (DLL).

Preferably, the comparison in step (i) occurs during runtime of the application.

According to a further aspect of the invention there is provided a method to repair a defective function in a library, including the steps of:
i) correcting the defect in a function in a dynamic form of the library; and
ii) updating a version code of the corrected function.

An application which is using the function may be compiled with a static form of the library which includes the defective copy of the function. The defective copy may have an earlier version code.

Preferably the method includes the following steps:
iii) the application comparing the version code of the defective function with the version code of the corrected function; and
iv) the application using the corrected function on the basis of the comparison.

The function may be an API or part of an API. The dynamic form of the library may be a DLL.

It is preferred that the application calls the defective function from the static form of the library and the comparison in step (iii) occurs when the defective function executes. It is further preferred that the defective function performs step (iv) by calling the corrected function in the dynamic function and failing to proceed with its own execution.

According to a further aspect of the invention there is provided a library for compilation with an application including:
one or more functions adapted to compare a version associated with the function with a version associated with a function in a dynamic library and to execute either the function or the function in the dynamic library on the basis of the comparison.

A single version may be associated with more than one function.

According to a further aspect of the invention there is provided a system for an application to use a library including:
i) a static library including a plurality of functions, wherein each function is associated with a version;
ii) a dynamic library including a plurality of functions, wherein each function corresponds with a function in the static library and each function is associated with a version; and
iii) an interface adapted to receive requests by an application for use of a function, adapted to compare the version of the static function with the version of the dynamic function, adapted to execute the dynamic function where the version of the dynamic function is later than the version of the static function, and adapted to execute the static function where the version of the dynamic function is not later than the version of the static function.

A single version may be associated with more than one function.

According to further aspects of the invention there is also provided a computer system for implementing the method of the first aspect, software for implementing for implementing the method of the first aspect, and storage media for storing the aforementioned software.

### BRIEF DESCRIPTION OF THE DRAWINGS

Embodiments of the invention will now be described, by way of example only, with reference to the accompanying drawings in which:

FIGS. 1 to 3: illustrate the operation of the method when a function is updated.

FIG. 4: illustrates how the invention may be utilised.

### DETAILED DESCRIPTION OF THE PREFERRED EMBODIMENTS

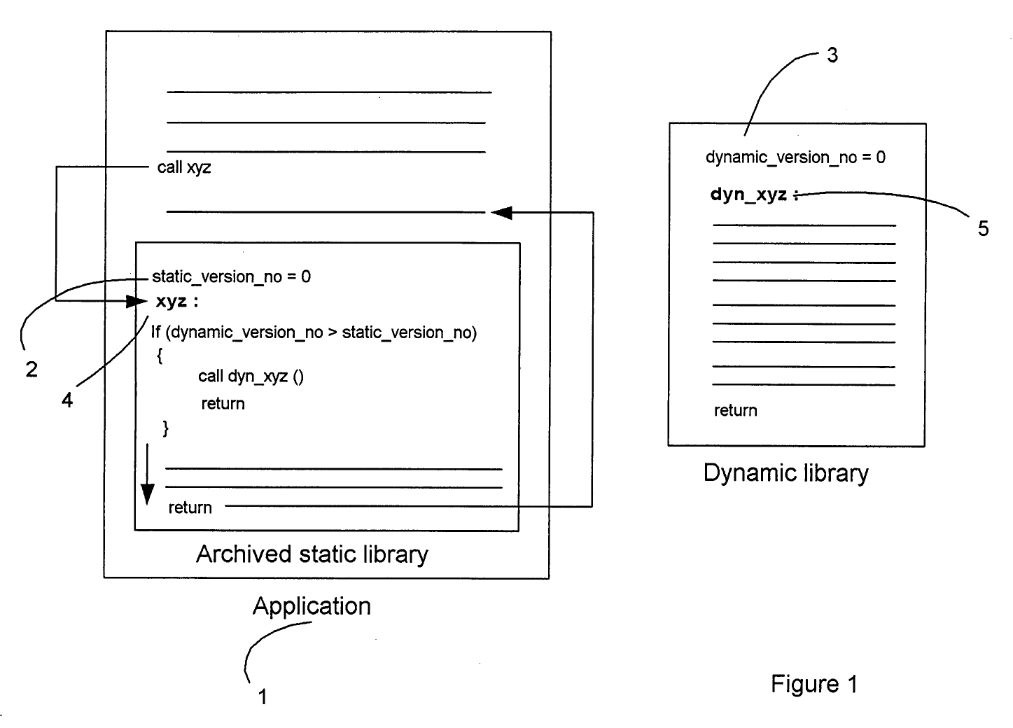

Referring to FIGS. 1 to 3 a preferred embodiment of the invention will be described.

The invention involves providing static as well as dynamic versions of the same library, associating a version number with all (or some) of the functions.

The functions may be application programming interfaces (API) or part of an application programming interface (API).

The invention will be described with reference to the use of functions from a library. However, it will be appreciated by those skilled in the art that the invention can be implemented for the use of data exported from the library.

The invention may be used for repairing defects in the library, updating the library, or providing performance enhancements to the library.

Applications are linked with both static and dynamic versions of the library. The symbol names corresponding to a function in the static and the dynamic versions of the library are chosen to be different so that both versions of the function will be accessible in an application at the same time. The symbol name corresponding to the function in the static library is the same as the function name. This means that all invocations of the function in the application are resolved to the symbol in the static library and ensures that whenever the application invokes the function, the static version gets control.

At the beginning of the static version of the function the following check is performed:

If (version_number of the shared_version > version_number of the
static_version)

Return( dyn_API(arguments));

Where:
“version_number of the shared_version” is the version number associated with the dynamic version of the function
“version_number of the static_version” is the version number associated with the static version of the function
“dyn_API” is the symbol name corresponding to the dynamic version of the function
“arguments” represent the arguments passed to the function

Preferably the static and dynamic versions of the functions are identified by version numbers, however, it will be appreciated that other methods can be used to identify the versions and compare them to determine the most recent. These methods include comparing time-date stamps for each version, comparison of size or other qualities of the functions, and comparing computed hash values of each version.

Referring to FIG. 1, when an application 1 is built and deployed, the version numbers 2 and 3 of both static 4 and dynamic 5 versions of the function will be the same. So the check mentioned above will fail and the static version 4 of the function will continue to execute.

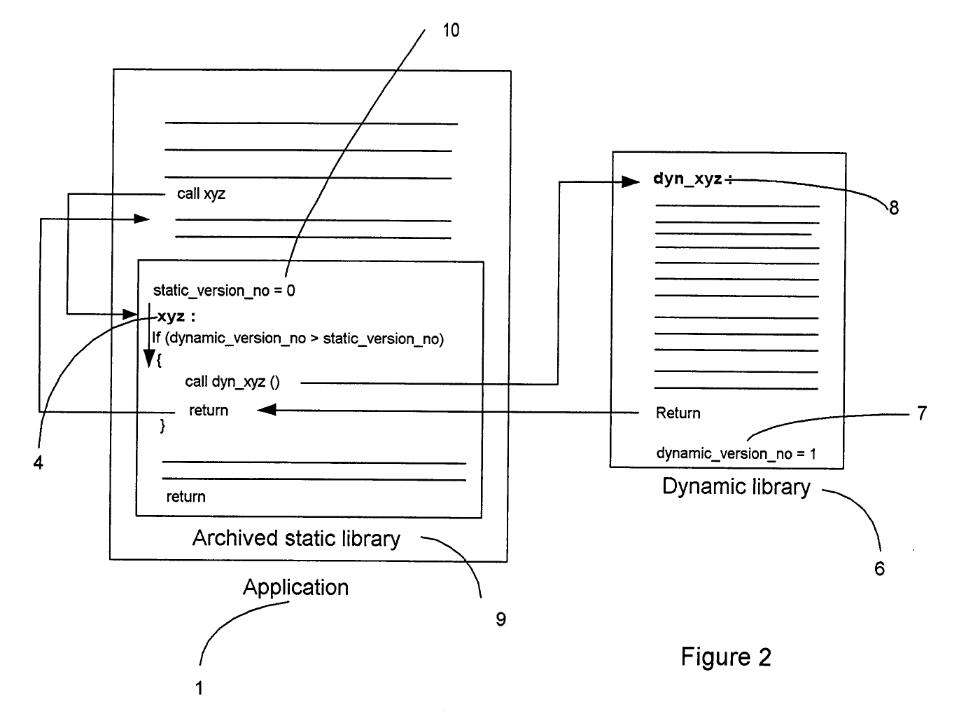

Referring to FIG. 2, when a defect is identified in the library later, a fix is made in both static 9 and dynamic 6 versions of the library and the version numbers 7 and 10 associated with both versions of that particular function are incremented.

When the new fixed versions of the libraries are installed on the machine, the fixed dynamic version 6 of the library will be visible to the application 1. But the fixed static library will not be visible to the application 1 since application binary has not been rebuilt. As a result the check in the static version of the function 4, which is archived into the application 1, will succeed and the fixed dynamic version of the function 8 will be executed.

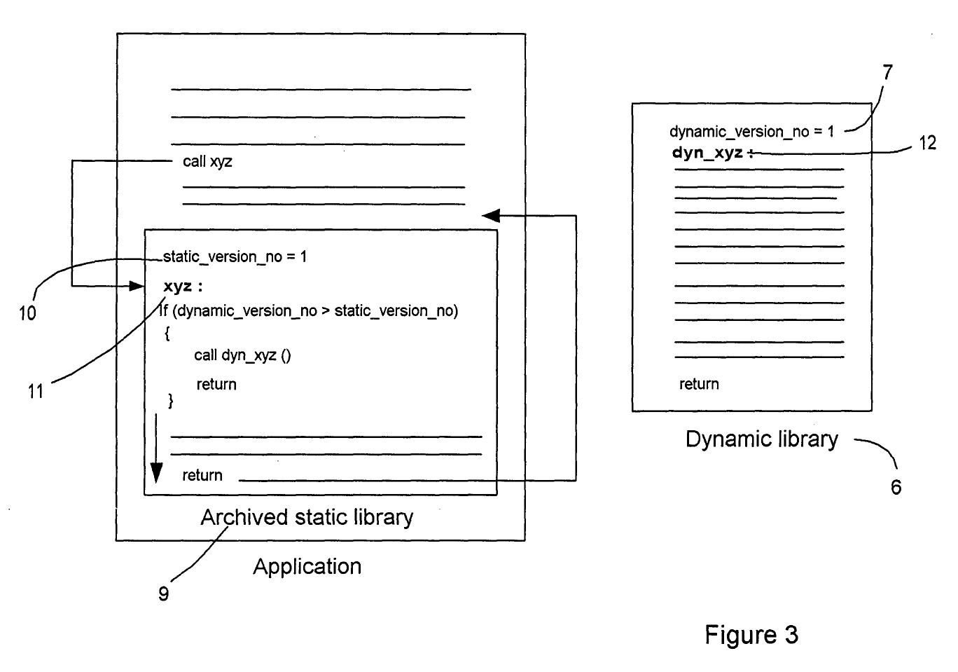

Referring to FIG. 3, if the application is rebuilt after installing the fixed libraries 6 and 9 on the machine, fixed versions of both libraries will be visible to the newly built application. So the version numbers 7 and 10 will match and as a result the version check will fail and the fixed static version of the function 11 will continue to execute instead of invoking the dynamic version 12.

### EXAMPLE OF THE METHOD

This example concerns a function which swaps the values of the two arguments passed to it. An implementation of this function in C could be:

Int swap(int *arg1, int *arg2)
{

int temp;
temp = *arg1;
*arg1= *arg2;
*arg2=temp;
return(0);

}

In order to provide fail over support for this function in an archive library the steps below are followed. This example assumes that the same source file will be used to generate both static as well as dynamic versions of the library and in such a case a macro STATIC is used as a macro guard.

1. Define a variable dynamic_swap_version in the dynamic version of the library and another variable static_swap_version in the static version and initialize both to 0.

#ifndef STATIC

int static_swap_version = 0;

#else

int dynamic_swap_version = 0;

#endif

2. Both static as well as dynamic versions of the function must be accessible to the application at the same time. So we change the symbol name in the dynamic link library by adding a prefix. This will also make sure that function invocations in the application always get resolved to the function in the static library.

#ifdef STATIC

int swap(int arg1, int arg2)

#else

int dyn_swap(int arg1 ,int arg2)

#endif

3. Include the following check at the beginning of the static version of the function so that the version check happens before executing the actual function implementation.

#ifdef STATIC

if (dynamic_swap_version > static_swap_version)

return(dyn_swap(arg1,arg2));

#endif

The modified implementation is given below:

#ifdef STATIC
int static_swap_version = 0;
#else
int dynamic_swap_version = 0;
#endif
#ifdef STATIC
int swap(int *arg1, int *arg2)
#else
int dyn_swap(int *arg1, int *arg2)
#endif
{

int temp;

#ifdef STATIC

if (dynamic_swap_version > static_swap_version)

return(dyn_swap(arg1 ,arg2));

#endif/* STATIC */

temp = *arg1;
*arg1=*arg2;
*arg2=temp;
return(0);

}

### Example of How the Method May Be Deployed

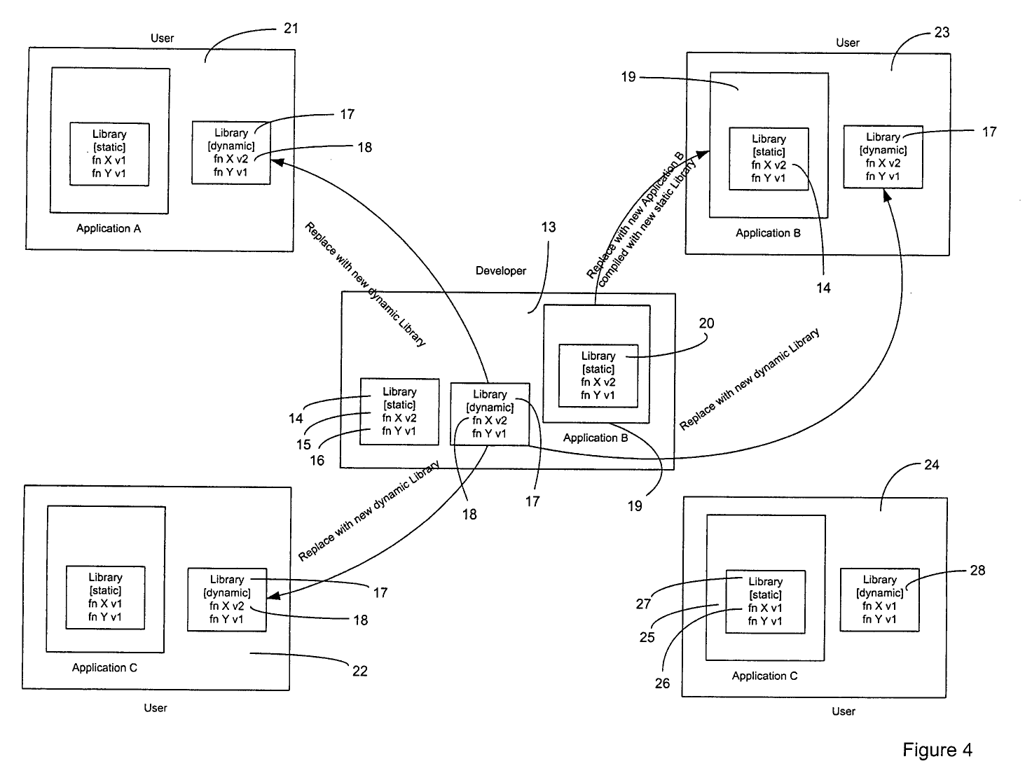

An example of how the method may be utilised will be described with reference to FIG. 4.

A library with two functions X and Y is utilised by three applications A, B, and C. The library exists in two forms—a static form which is archived into each application which uses the library, and a dynamic form which exists separately from the applications and may be shared by other applications.

Each of the applications is initially compiled with the static library which has version 1 of both functions X and Y. This results in the static library being archived within the applications. The applications and the dynamic library are deployed to the computer systems of four users.

Function X is updated by the developer 13. A new static library 14 is compiled with function X 15 assigned version 2, function Y 16 has not changed and is still version 1. A new dynamic library 17 is compiled with function X 18 assigned version 2. In this example application B 19 is recompiled by the developer. During recompilation of application B, the new static library 20 is archived into the application.

The new dynamic library is deployed to users 21 and 22. When applications A and C on these computer systems call function X, the function X 18 in the dynamic library 17 will execute because it is the latest version of the function.

The new application B 19 and the new dynamic library 17 are deployed onto the computer system of user 23. When application B 19 calls function X, the function X 15 within the static library 20 archived within application B will execute as it has the latest version of function X.

User 24 has not been updated by the developer with a new application C or a new dynamic library. On this system when application C 25 calls function X, version 1 of function X 26 within the archived static library 27 will execute as the dynamic library 28 does not have a newer version of the function.

The invention has the following advantages:
Fixes for defects or updates in static libraries can be provided without requiring the application to be rebuilt. Presently, whenever a fix for a defect in a static library is delivered, a software developer/vendor needs to ask all customers to rebuild their applications.
There is no significant performance degradation to implementation of the invention within libraries. On EPIC based architectures like IA64 all the additional computation required to support this functionality can be done in parallel. So the overall performance overhead is only a few clock cycles.
The invention supports disabling static versions of only selected functions. So the method provides better control.

It will be appreciated by those skilled in the art that the method described herein is not specific to any particular architecture or programming language. However the method is more effective on architectures like IA64, which supports explicit control over parallel execution of multiple instructions. As noted above, the invention may be applied to data revisions in libraries. That is, is data is updated or amended in a library, the same technique may be applied to determine the version number of the data block and its substitution where necessary.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for using a function from a library including the steps of:
i) comparing a version of the function in a static form of the library with a version of the function in a dynamic form of the library;
ii) using the function from the dynamic form of the library when the comparison indicates that the dynamic version is more recent than the static version; and
iii) using the function from the static form of the library when the comparison indicates that the dynamic version is not more recent than the static version.

2. A method as claimed in claim 1 wherein each version is recorded as a version code.

3. A method as claimed in claim 2 wherein the dynamic form of the library is a Dynamic Linked Library (DLL).

4. A method as claimed in claim 2 wherein a different symbol identifies the function in the static form of the library and the dynamic form of the library.

5. A method as claimed in claim 2 wherein the comparison in step (i) occurs during execution of the function from the static form of the library.

6. A method as claimed in claim 2 wherein the comparison in step (i) occurs at substantially the beginning of execution of the function.

7. A method as claimed in claim 2 wherein the static form of the library is archived within the application which is using the function.

8. A method as claimed in claim 2 wherein the function is part of an Application Programming Interface (API).

9. A method as claimed in claim 2 wherein the comparison in step (i) occurs during runtime of the application.

10. A method of repairing a defective function in a library, including the steps of:
i) correcting the defect in a function in a dynamic form of the library; and
ii) updating a version code of the corrected function.

11. A method as claimed in claim 10 wherein an application using the function has been compiled with a static form of the library.

12. A method as claimed in claim 11 wherein the static form of the library includes the defective function with an earlier version code.

13. A method as claimed in claim 12 including the step of:
iii) the application comparing the version code of the defective function with the version code of the corrected function; and
iv) the application using the corrected function on the basis of the comparison.

14. A method as claimed in claim 13 wherein the function is part of an Application Programming Interface (API).

15. A method as claimed in claim 13 wherein the comparison in step (i) occurs within the defective function.

16. A method as claimed in claim 13 wherein the dynamic form of the library is a Dynamic Linked Library (DLL).

17. A library for compilation with an application including:
one or more functions adapted to compare a version associated with the function with a version associated with a function in a dynamic library and to execute either the function or the function in the dynamic library on the basis of the comparison.

18. A library as claimed in claim 17 wherein a plurality of functions may be associated with a single version.

19. A library as claimed in claim 17 wherein each version is recorded as a version code.

20. A library as claimed in claim 19 wherein the function is part of an Application Programming Interface (API).

21. A library as claimed in claim 19 wherein the dynamic library is a Dynamic Linked Library (DLL).

22. A system for an application to use a library including:
i) a static library including a plurality of functions, wherein each function is associated with a version;
ii) a dynamic library including a plurality of functions, wherein each function corresponds with a function in the static library and each function is associated with a version; and
iii) an interface adapted to receive requests by an application for use of a function, adapted to compare the version of the static function with the version of the dynamic function, adapted to execute the dynamic function where the version of the dynamic function is later than the version of the static function, and adapted to execute the static function where the version of the dynamic function is not later than the version of the static function.

23. A system as claimed in claim 22 wherein a plurality of functions may be associated with a single version.

24. A system as claimed in claim 22 wherein each version is recorded as a version code.

25. A system as claimed in claim 22 wherein the static library is archived within the application.

26. A system as claimed in claim 22 wherein the interface is incorporated into the static library.

27. A method for using data from a library, including the steps of:
i) comparing a version of the data in a dynamic form of the library with a version of the data in a static form of the library;
ii) using the data from the dynamic form of the library when the comparison indicates that the dynamic version is more recent than the static version; and
iii) using the data from the static form of the library when the comparison indicates that the dynamic version is not more recent than the static version.

28. A computer system adapted for effecting the method of claim 1.

29. Software for effecting the method of claim 1.

30. Storage media containing the software of claim 29.
